(19) United States
(12) Patent Application Publication
(10) Pub. No.: US 2026/0166916 A1
(43) Pub. Date: Jun. 18, 2026

(54) HUB FOR HUMAN-POWERED VEHICLE AND WHEEL FOR HUMAN-POWERED VEHICLE

(71) Applicant: Shimano Inc., Sakai City (JP)

(72) Inventor: Takuya YAMASHITA, Sakai City (JP)

(21) Appl. No.: 18/984,874

(22) Filed: Dec. 17, 2024

(51) Int. Cl. B60B 1/04; B60B 1/00

(52) U.S. Cl. CPC B60B 1/042; B60B 1/003

(57) ABSTRACT

A hub for a wheel of a human-powered vehicle comprises, a hub body and first and second spoke seats portions arranged at opposite sides of the hub body. The first spoke seats portion includes a first outer surface extending circumferentially, inner recesses, each receiving an inner spoke, and outer recesses, each receiving an outer spoke. The inner recesses and the outer recesses are arranged in the first outer surface. The inner spoke intersects with the outer spoke as viewed axially. Each inner recess has an axial inner opening and an inner additional opening which opens in the first outer surface. The inner spoke extends through the inner additional opening. The outer recess has an axial outer opening facing away from the axial inner opening and an outer additional opening which opens in the first outer surface. The outer spoke extends through the outer additional opening.

### BACKGROUND ART

The present disclosure relates to a hub for a human-powered vehicle and a wheel for a human-powered vehicle.

European Patent Application Publication No. 3112183 discloses a hub for a human-powered vehicle that includes a spoke seats portion.

### SUMMARY OF THE DISCLOSURE

One objective of the present disclosure is to provide a hub for a human-powered vehicle and a wheel for a human-powered vehicle that allow for simple attachment of spokes to a spoke seats portion.

A hub in accordance with a first aspect of the present disclosure is for a wheel of a human-powered vehicle. The hub comprises a hub body, a first spoke seats portion, and a second spoke seats portion. The hub body includes a central axis defining an axial direction, a radial direction, and a circumferential direction. The hub body further includes a plane defined extending perpendicular to the axial direction and containing an axial center position of the hub body. The first spoke seats portion is configured to support spokes. The first spoke seats portion includes a first outer surface at least partially extending in the circumferential direction and a plurality of first spoke seats sections disposed in the circumferential direction. Each of the plurality of first spoke seats sections includes a first inner recess and a first outer recess. The first outer recess is located farther from the axial center position than the first inner recess in the axial direction. The first inner recess receives a first inner spoke. The first outer recess receives a first outer spoke. The first inner spoke intersects with the first outer spoke at an intersecting position as viewed from the axial direction. The first outer spoke is located farther from the axial center position than the first inner spoke at the intersecting position. The first inner recess has a first axial inner opening facing toward the plane. The first inner recess has a first inner additional opening which opens in the first outer surface. The first inner spoke extends through the first inner additional opening. The first outer recess has a first axial outer opening facing away from the plane. The first outer recess has a first outer additional opening which opens in the first outer surface. The first outer spoke extends through the first outer additional opening. The second spoke seats portion is configured to support spokes. The second spoke seats portion and the first spoke seats portion are arranged at opposite sides of the axial center position in the axial direction.

With the hub according to the first aspect, the first inner recess receives the first inner spoke and the first outer recess receives the first outer spoke so that the first outer spoke is located farther from the axial center position than the first inner spoke at the intersecting position. This structure allows for removal of the first inner spoke from the hub while the first outer spoke remains in the first outer recess, and allows for removal of the first outer spoke from the hub while the first inner spoke remains in the first inner recess. Thus, each spoke can be individually replaced with another spoke without the need to remove the other spokes from the hub.

In accordance with a second aspect of the present disclosure, the hub according to the first aspect is configured so that the first inner recess is entirely offset from the first outer recess in the circumferential direction.

With the hub according to the second aspect, the first inner recess is entirely offset from the first outer recess in the circumferential direction. This allows for reduction in the size of the first spoke seats portion in the axial direction.

In accordance with a third aspect of the present disclosure, the hub according to the first or second aspect is configured so that the first spoke seats portion includes a ring arranged outward from the hub body in the radial direction and extending continuously around the hub body in the circumferential direction, and bridges extending in the radial direction and connecting the hub body and the ring. The first inner recess and the first outer recess are provided in the ring.

With the hub according to the third aspect, the ring extends continuously around the hub body in the circumferential direction. This increases the mechanical strength of the hub while allowing for replacement of each spoke without the need to remove another spoke from the hub.

In accordance with a fourth aspect of the present disclosure, the hub according to the third aspect is configured so that the first inner recess is located a first distance away from the hub body in a first inner spoke axial direction in which the first inner spoke received in the first inner recess extends. The first distance is greater than a first length of the first inner recess in the first inner spoke axial direction.

With the hub according to the fourth aspect, in a state in which the first inner spoke is received in the first inner recess, the head of the first inner spoke can be readily moved between the hub body and the ring in the first inner spoke axial direction.

In accordance with a fifth aspect of the present disclosure, the hub according to the third or fourth aspect is configured so that the first outer recess is located a second distance away from the hub body in a first outer spoke axial direction in which the first outer spoke received in the first outer recess extends. The second distance is greater than a second length of the first outer recess in the first outer spoke axial direction.

With the hub according to the fifth aspect, in a state in which the first outer spoke is received in the first outer recess, the head of the first outer spoke can be readily moved between the hub body and the ring in the first outer spoke axial direction.

In accordance with a sixth aspect of the present disclosure, the hub according to any one of the third to fifth aspects is configured so that a number of the bridges is equal to a sum of the first inner recesses and the first outer recesses.

With the hub according to the sixth aspect, the bridges provide mechanical strength in a preferred manner.

In accordance with a seventh aspect of the present disclosure, the hub according to any one of the first to sixth aspects is configured so that the first inner recess extends straight and has a first length. The first axial inner opening of the first inner recess has a first width in a first direction orthogonal to a longitudinal direction of the first inner recess. The first width is less than a maximum width of the first inner recess in the first direction.

With the hub according to the seventh aspect, since the first width of the first axial inner opening is less than the maximum width of the first inner recess in the first direction, removal of the first inner spoke from the first axial inner opening in the axial direction is restricted.

In accordance with an eighth aspect of the present disclosure, the hub according to the seventh aspect is configured so that the first width of the first axial inner opening of the first inner recess is greater than or equal to one-half of the maximum width of the first inner recess in the first direction.

With the hub according to the eighth aspect, removal of the first inner spoke from the first axial inner opening in the axial direction is restricted in a further ensured manner.

In accordance with a ninth aspect of the present disclosure, the hub according to any one of the third to sixth aspects is configured so that the first inner recess includes a first inner edge that opens in the first outer surface, a second inner edge disposed in a radially inner surface of the ring, and a first inner intermediate portion located between the first inner edge and the second inner edge. The first inner intermediate portion and the second inner edge are equal in maximum diameter.

With the hub according to the ninth aspect, since the first inner intermediate portion and the second inner edge are equal in maximum diameter, the formation of the first inner intermediate portion and the second inner edge is simplified.

In accordance with a tenth aspect of the present disclosure, the hub according to any one of the first to ninth aspects is configured so that the first outer recess extends straight and has a second length. The first axial outer opening of the first outer recess has a second width in a second direction orthogonal to a longitudinal direction of the first outer recess. The second width is less than a maximum width of the first outer recess in the second direction.

With the hub according to the tenth aspect, since the second width of the first axial outer opening is less than the maximum width of the first outer recess in the second direction, removal of the first outer spoke from the first axial outer opening in the axial direction is restricted.

In accordance with an eleventh aspect of the present disclosure, the hub according to the tenth aspect is configured so that the second width of the first axial outer opening of the first outer recess is greater than or equal to one-half of the maximum width of the first outer recess in the second direction.

With the hub according to the eleventh aspect, removal of the first outer spoke from the first axial outer opening in the axial direction is restricted in a further ensured manner.

In accordance with a twelfth aspect of the present disclosure, the hub according to the first or second aspect is configured so that the first outer recess includes a first outer edge that opens in the first outer surface, a second outer edge disposed in a radially inner surface of the ring, and a first outer intermediate portion located between the first outer edge and the second outer edge. The first outer intermediate portion and the second outer edge are equal in maximum diameter.

With the hub according to the twelfth aspect, since the first outer intermediate portion and the second outer edge are equal in maximum diameter, the formation of the first outer intermediate portion and the second outer edge is simplified.

A wheel in accordance with a thirteenth aspect of the present disclosure is for a human-powered vehicle. The wheel comprises the hub according to any one of the first to twelfth aspects, the first inner spoke, the first outer spoke, and a rim.

With the wheel according to the thirteenth aspect, each spoke can be individually replaced with another spoke without the need to remove the other spokes from the wheel.

In accordance with a fourteenth aspect of the present disclosure, the wheel according to the thirteenth aspect is configured so that the first inner spoke includes an inner spoke axis defining a first inner spoke axial direction, a first inner spoke end attached to the hub in the first inner spoke axial direction, a second inner spoke end attached to the rim in the first inner spoke axial direction, a first inner spoke portion extending continuously from the first inner spoke end and located closer to the second inner spoke end than the first inner spoke end, and a second inner spoke portion extending continuously from the first inner spoke portion and located closer to the second inner spoke end than the first inner spoke portion. A maximum diameter of the first inner spoke end is greater than a maximum diameter of the first inner spoke portion. The maximum diameter of the first inner spoke portion is greater than a maximum diameter of the second inner spoke portion. The first outer spoke includes an outer spoke axis defining a first outer spoke axial direction, a first outer spoke end attached to the hub in the first outer spoke axial direction, a second outer spoke end attached to the rim in the first outer spoke axial direction, a first outer spoke portion extending continuously from the first outer spoke end and located closer to the second outer spoke end than the first outer spoke end, and a second outer spoke portion extending continuously from the first outer spoke portion and located closer to the second outer spoke end than the first outer spoke portion. A maximum diameter of the first outer spoke end is greater than a maximum diameter of the first outer spoke portion. The maximum diameter of the first outer spoke portion is greater than a maximum diameter of the second outer spoke portion.

With the wheel according to the fourteenth aspect, the first inner spoke and the first outer spoke having the structures described above are coupled to the hub in a preferred manner.

A wheel in accordance with a fifteenth aspect of the present disclosure is for a human-powered vehicle. The wheel comprises the hub according to the fourth aspect, the first inner spoke, and a rim. The first inner spoke includes an inner spoke axis defining a first inner spoke axial direction, a first inner spoke end attached to the hub in the first inner spoke axial direction, a second inner spoke end attached to the rim in the first inner spoke axial direction, a first inner spoke portion extending continuously from the first inner spoke end and located closer to the second inner spoke end than the first inner spoke end, and a second inner spoke portion extending continuously from the first inner spoke portion and located closer to the second inner spoke end than the first inner spoke portion. A maximum diameter of the first inner spoke end is greater than a maximum diameter of the first inner spoke portion. The maximum diameter of the first inner spoke portion is greater than a maximum diameter of the second inner spoke portion. The first distance is greater than a sum of a length of the first inner spoke end and a length of the first inner spoke portion.

With the wheel according to the fifteenth aspect, the first inner spoke end and the first inner spoke portion can both be received in an open area extending over the first distance and moved between the hub body and the ring in the first inner spoke axial direction.

A wheel in accordance with a sixteenth aspect of the present disclosure is for a human-powered vehicle. The wheel comprises the hub according to the fifth aspect, the first outer spoke, and a rim. The first outer spoke includes an outer spoke axis defining a first outer spoke axial direction, a first outer spoke end attached to the hub in the first outer spoke axial direction, a second outer spoke end attached to the rim in the first outer spoke axial direction, a first outer spoke portion extending continuously from the first outer spoke end and located closer to the second outer spoke end than the first outer spoke end, and a second outer spoke portion extending continuously from the first outer spoke portion and located closer to the second outer spoke end than the first outer spoke portion. A maximum diameter of the first outer spoke end is greater than a maximum diameter of the first outer spoke portion. The maximum diameter of the first outer spoke portion is greater than a maximum diameter of the second outer spoke portion. The second distance is greater than a sum of a length of the first outer spoke end and a length of the first outer spoke portion.

With the wheel according to the sixteenth aspect, the first outer spoke end and the first outer spoke portion can both be received in an open area extending over the second distance and moved between the hub body and the ring in the first outer spoke axial direction.

A wheel in accordance with a seventeenth aspect of the present disclosure is for a human-powered vehicle. The wheel comprises the hub according to the seventh or eighth aspect, the first inner spoke, and a rim. The first inner spoke includes an inner spoke axis defining a first inner spoke axial direction, a first inner spoke end attached to the hub in the first inner spoke axial direction, a second inner spoke end attached to the rim in the first inner spoke axial direction, a first inner spoke portion extending continuously from the first inner spoke end and located closer to the second inner spoke end than the first inner spoke end, and a second inner spoke portion extending continuously from the first inner spoke portion and located closer to the second inner spoke end than the first inner spoke portion. A maximum diameter of the first inner spoke end is greater than a maximum diameter of the first inner spoke portion. The maximum diameter of the first inner spoke portion is greater than a maximum diameter of the second inner spoke portion. The first width is less than the maximum diameter of the first inner spoke portion and greater than the maximum diameter of the second inner spoke portion.

With the wheel according to the seventeenth aspect, the first inner spoke can be coupled to the hub by inserting the second inner spoke portion into the first axial inner opening in the axial direction and then moving the first inner spoke in the first inner spoke axial direction. In this state, since the first width is less than the maximum diameter of the first inner spoke portion, movement of the first inner spoke in the axial direction is restricted. Thus, the first inner spoke cannot be removed from the hub as long as the first inner spoke is coupled to the rim.

A wheel in accordance with an eighteenth aspect of the present disclosure is for a human-powered vehicle. The wheel comprises the hub according to the tenth or eleventh aspect, the first outer spoke, and a rim. The first outer spoke includes an outer spoke axis defining a first outer spoke axial direction, a first outer spoke end attached to the hub in the first outer spoke axial direction, a second outer spoke end attached to the rim in the first outer spoke axial direction, a first outer spoke portion extending continuously from the first outer spoke end and located closer to the second outer spoke end than the first outer spoke end, and a second outer spoke portion extending continuously from the first outer spoke portion and located closer to the second outer spoke end than the first outer spoke portion. A maximum diameter of the first outer spoke end is greater than a maximum diameter of the first outer spoke portion. The maximum diameter of the first outer spoke portion is greater than a maximum diameter of the second outer spoke portion. The second width is less than the maximum diameter of the first outer spoke portion and greater than the maximum diameter of the second outer spoke portion.

With the wheel according to the eighteenth aspect, the first outer spoke can be coupled to the hub by inserting second outer spoke portion into the first axial outer opening in the axial direction and then moving the first outer spoke in the first outer spoke axial direction. In this state, since the second width is less than the maximum diameter of the first outer spoke portion, movement of the first outer spoke in the axial direction is restricted. Thus, the first outer spoke cannot be removed from the hub as long as the first outer spoke is coupled to the rim.

The hub for a human-powered vehicle and the wheel for a human-powered vehicle according to the present disclosure allow for simple attachment of spokes to the spoke seats portion.

### BRIEF DESCRIPTION OF THE DRAWINGS

FIG. 1 is a side view of a wheel for a human-powered vehicle including a first embodiment of a hub for a human-powered vehicle.

FIG. 2 is an enlarged partial view of FIG. 1.

FIG. 3 is a perspective view showing a portion of the wheel shown in FIG. 1.

FIG. 4 is a perspective view of the hub shown in FIG. 1.

FIG. 5 is a front view of the hub shown in FIG. 1.

FIG. 6 is a cross-sectional view taken along line D6-D6 in FIG. 5.

FIG. 7 is a cross-sectional view taken from a side opposite to the cross-sectional view of FIG. 6.

FIG. 8 is an enlarged partial side view of the hub shown in FIG. 6.

FIG. 9 is a plan view of a first inner recess shown in FIG. 8 taken in a first inner spoke axial direction.

FIG. 10 is an enlarged partial side view of the hub shown in FIG. 7.

FIG. 11 is a plan view of a first outer recess shown in FIG. 10 taken in a first outer spoke axial direction.

FIG. 12 is a side view of a first inner spoke shown in FIG. 1.

FIG. 13 is a perspective view of the first inner spoke including a first inner spoke end.

FIG. 14 is an enlarged side view of the first inner spoke shown in FIG. 12 including the first inner spoke end.

FIG. 15 is a side view of a first outer spoke shown in FIG. 1.

FIG. 16 is a perspective view of the first outer spoke shown in FIG. 15 including a first outer spoke end.

FIG. 17 is an enlarged side view of the first outer spoke shown in FIG. 15 including the first outer spoke end.

FIG. 18 is a side view of the first inner spoke shown in FIG. 1 before being coupled to the first inner recess.

FIG. 19 is a side view of the first inner spoke that is coupled to the first inner recess shown in FIG. 18.

FIG. 20 is a perspective view showing a portion of a wheel for a human-powered vehicle including a second embodiment of a hub for a human-powered vehicle.

FIG. 21 is a side view of the hub shown in FIG. 20 including a second spoke seats portion.

FIG. 22 is a cross-sectional view taken along line D22-D22 in FIG. 21.

FIG. 23 is a front view of the second spoke seats portion of the hub shown in FIG. 21.

FIG. 24 is a cross-sectional view taken along line D24-D24 in FIG. 23.

FIG. 25 is a cross-sectional view of a second spoke before being coupled to a second seat of a second spoke seats portion shown in FIG. 20.

FIG. 26 is a cross-sectional view of the second spoke coupled to the second seat of the second spoke seats portion 26.

FIG. 27 is a cross-sectional view taken along line D27-D27 in FIG. 26.

FIG. 28 is a perspective view showing a modified example of a hub for a human-powered vehicle.

### EMBODIMENTS OF THE DISCLOSURE

### First Embodiment

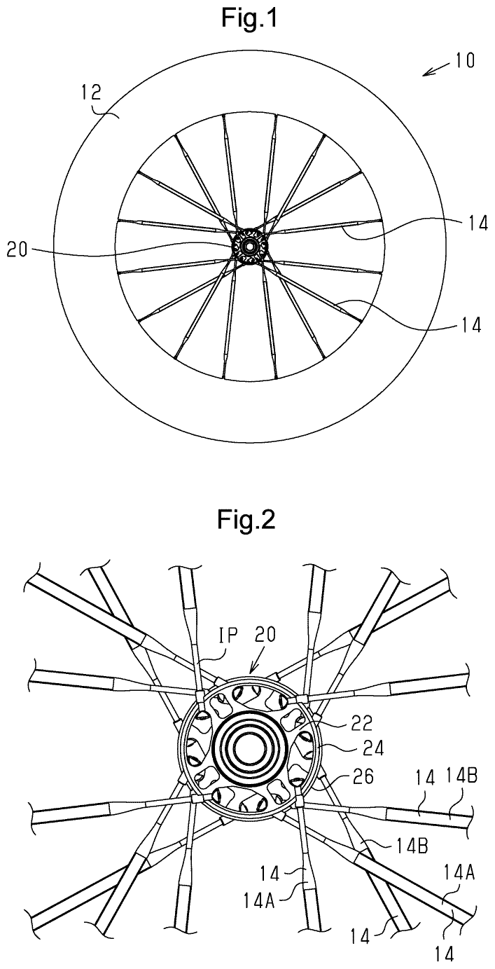

A first embodiment of a wheel 10 for a human-powered vehicle will now be described with reference to FIGS. 1 to 19. The human-powered vehicle is a vehicle including at least one wheel and driven by at least human driving force. The human-powered vehicle includes, for example, various types of bicycles such as a mountain bike, a road bike, a city bike, a cargo bike, a hand bike, and a recumbent bike. The number of wheels on the human-powered vehicle is not limited. The human-powered vehicle includes, for example, a unicycle and a vehicle including two or more wheels. The human-powered vehicle is not limited to a vehicle configured to be driven only by human driving force. The human-powered vehicle includes an E-bike that uses driving force of an electric motor in addition to human driving force for propulsion. The E-bike includes an electric assist bicycle that assists in propulsion with an electric motor. In the embodiments described below, the human-powered vehicle refers to a bicycle.

FIG. 1 is a diagram showing an example of the wheel 10 as a front wheel. In FIG. 1, a tire is not mounted on the wheel 10. The wheel 10 includes a rim 12, spokes 14, and a hub 20.

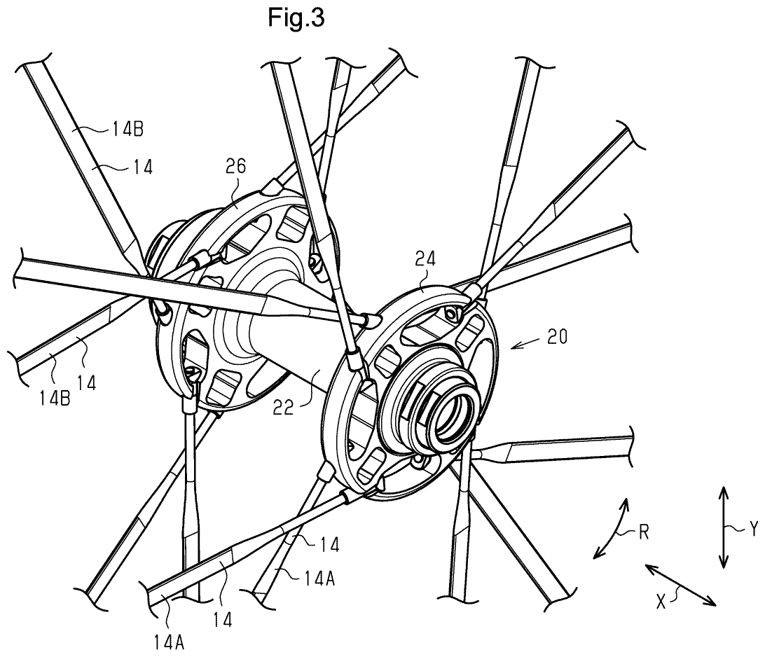

As shown in FIGS. 1 and 2, in an example, the wheel 10 includes the hub 20, a first inner spoke 16, a first outer spoke 18, and the rim 12. As shown in FIG. 3, the spokes 14 include, for example, first spokes 14A and second spokes 14B. The first spokes 14A include, for example, the first inner spoke 16 and the first outer spoke 18.

The hub 20 will now be described in detail with reference to FIGS. 3 to 5. The hub 20 includes a hub body 22, a first spoke seats portion 24, and a second spoke seats portion 26. The hub body 22 includes a central axis C1 defining an axial direction X, a radial direction Y, and a circumferential direction R. The hub body 22 further includes a plane P1 defined extending perpendicular to the axial direction X and containing an axial center position ACP1 of the hub body 22.

The first spoke seats portion 24 is configured to support spokes 14. The first spoke seats portion 24 is configured to support first spokes 14A. The second spoke seats portion 26 is configured to support spokes 14. The second spoke seats portion 26 is configured to support second spokes 14B. The second spoke seats portion 26 and the first spoke seats portion 24 are arranged at opposite sides of the axial center position ACP1 in the axial direction X. The axial center position ACP1 is located in the center of the hub body 22 in the axial direction X.

In the present embodiment, the axial direction X defined by the central axis C1 includes a first axial direction and a second axial direction opposite to the first axial direction. The hub 20 includes a first hub end located at a side corresponding to the first axial direction and a second hub end opposite to the first hub end. The first spoke seats portion 24 extends circumferentially on the first hub end.

In the present embodiment, the second spoke seats portion 26 has the same structure as the first spoke seats portion 24. More specifically, the second spoke seats portion 26 and the first spoke seats portion 24 have symmetrical structures.

The diameter of the second spoke seats portion 26 can be the same as or differ from the diameter of the first spoke seats portion 24. In a case where the second spoke seats portion 26 and the first spoke seats portion 24 have different diameters, the second spoke 14B and the first spoke 14A can have different lengths.

The first spoke seats portion 24 and the second spoke seats portion 26 are each defined in a flange extending radially outward from the hub body 22. In the description hereafter, the first spoke seats portion 24 refers to the spoke seats portion located at a side corresponding to the right side of a rider facing a traveling direction of the human-powered vehicle.

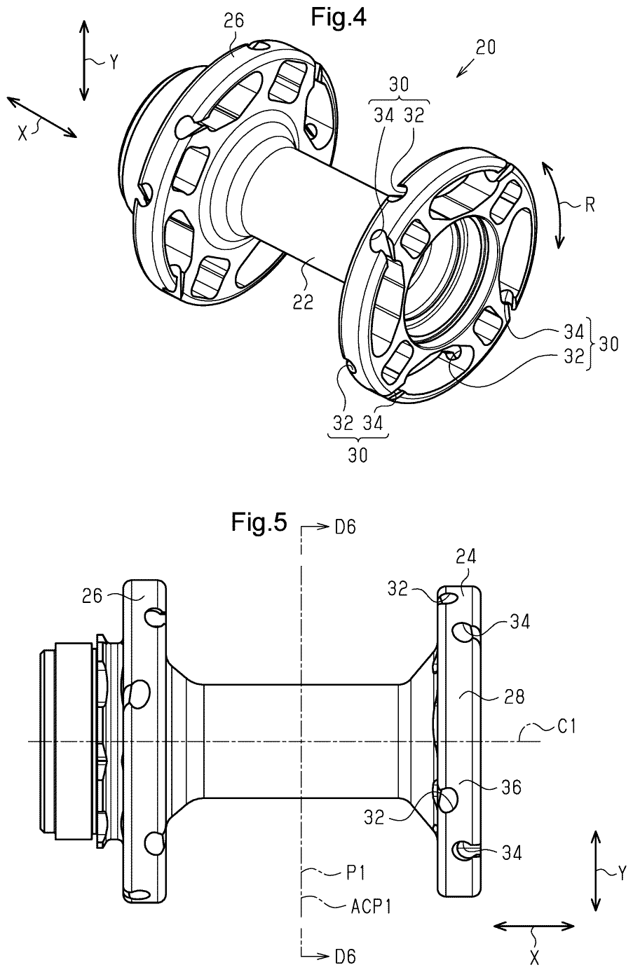

As shown in FIG. 4, for example, the first spoke seats portion 24 includes a first outer surface 28 and a plurality of first spoke seats sections 30. The first outer surface 28 at least partially extends in the circumferential direction R. The plurality of first spoke seats sections 30 are disposed in the circumferential direction R. As shown in FIG. 5, for example, each of the plurality of first spoke seats sections 30 includes a first inner recess 32 and a first outer recess 34. The first outer recess 34 is located farther from the axial center position ACP1 than the first inner recess 32 in the axial direction X. The first inner recess 32 receives the first inner spoke 16. The first outer recess 34 receives a first outer spoke 18.

In an example, the plurality of first spoke seats sections 30 each include a single first inner recess 32 and a single first outer recess 34. In an example, the plurality of first spoke seats sections 30 are disposed at equal intervals in the circumferential direction R. In an example, adjacent ones of the first spoke seats sections 30 are entirely offset from each other in the circumferential direction R.

In an example, the number of the plurality of first spoke seats sections 30 is four. The number of the plurality of first spoke seats sections 30 can be three or less or five or more. The first inner recesses 32 of the plurality of first spoke seats sections 30 have identical structures. The first outer recesses 34 of the plurality of first spoke seats sections 30 have identical structures.

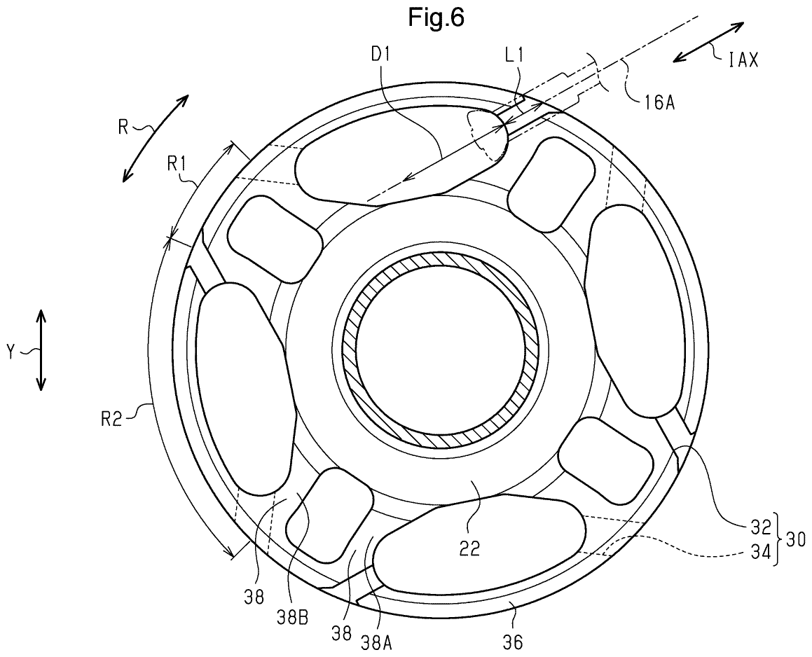

As shown in FIGS. 6 and 7, the first spoke seats portion 24 includes a ring 36 and bridges 38. The ring 36 is arranged outward from the hub body 22 in the radial direction Y and extends continuously around the hub body 22 in the circumferential direction R. The bridges 38 extend in the radial direction Y and connect the hub body 22 and the ring 36. The first inner recesses 32 and the first outer recesses 34 are provided in the ring 36. The first outer surface 28 is defined on an outer surface of the ring 36. The ring 36 is continuous over 360 degrees.

In an example, the number of the bridges 38 is equal to the sum of the first inner recesses 32 and the first outer recesses 34. In an example, each of the bridges 38 includes a first bridge 38A located close to the first inner recess 32 and a second bridge 38B located close to the first outer recess 34. In an example, the first inner recess 32 is partially provided in the first bridge 38A. In an example, the first outer recess 34 is partially provided in the second bridge 38B.

In an example, the number of the first bridges 38A is equal to the number of the first inner recesses 32. In an example, the number of the second bridges 38B is equal to the number of the first outer recesses 34. In an example, the ring 36 has a dimension in the radial direction that is less than that of each bridge 38.

In an example, the hub 20 can be formed as a single-piece component integrally including the hub body 22, the ring 36, and the bridges 38. In an example, the hub 20 can be a metal component, and the hub 20 can be manufactured by any metal product forming methods, such as casting, metal cutting, and other known process(es). In an example, the hub 20 can be machined to obtain the recesses and other holes such as spoke sockets.

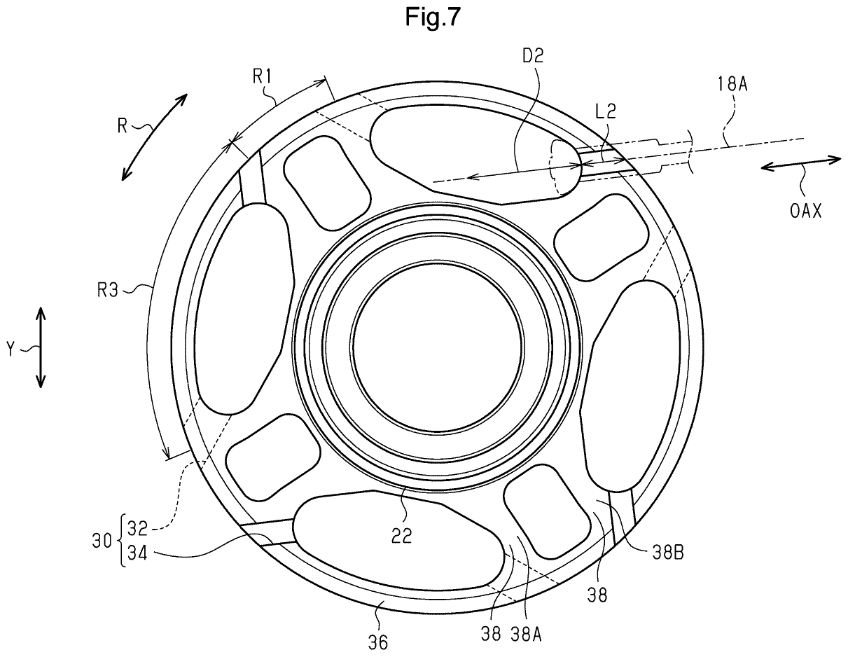

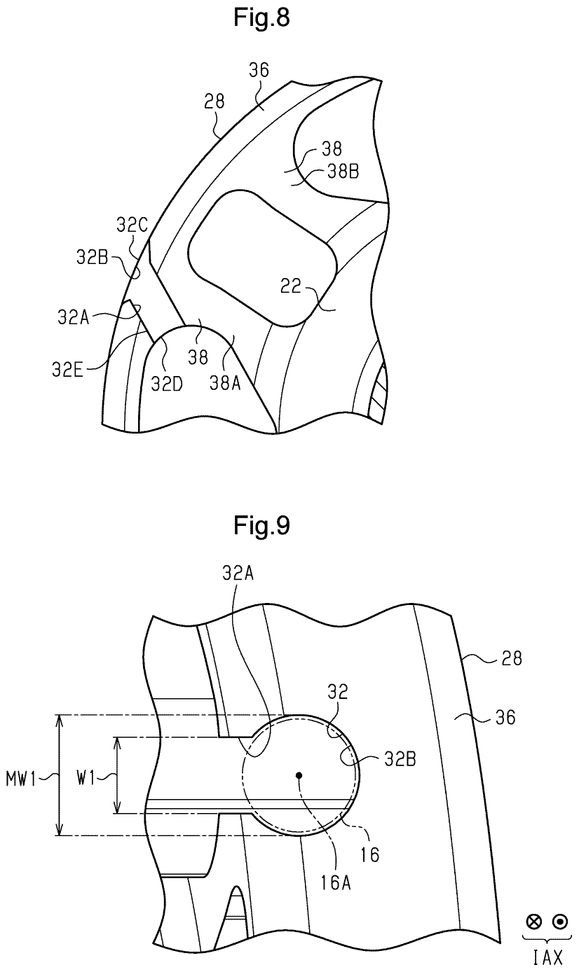

As shown in FIG. 8, each first inner recess 32 has a first axial inner opening 32A facing toward the plane P1. In addition, the first inner recess 32 has a first inner additional opening 32B which opens in the first outer surface 28. The first inner spoke 16 extends through the first inner additional opening 32B.

As shown in FIG. 6, the first inner recess 32 is located a first distance D1 away from the hub body 22 in a first inner spoke axial direction IAX in which the first inner spoke 16 received in the first inner recess 32 extends. The first distance D1 is greater than a first length L1 of the first inner recess 32 in the first inner spoke axial direction IAX.

In an example, the first inner recess 32 extends straight and has a first length L1. As shown in FIG. 9, the first axial inner opening 32A of the first inner recess 32 has a first width W1 in a first direction orthogonal to a longitudinal direction of the first inner recess 32. The first width W1 is less than a maximum width MW1 of the first inner recess 32 in the first direction. In an example, the first width W1 of the first axial inner opening 32A of the first inner recess 32 is greater than or equal to one-half of the maximum width MW1 of the first inner recess 32 in the first direction.

As shown in FIG. 8, the first inner recess 32 includes a first inner edge 32C that opens in the first outer surface 28, a second inner edge 32D disposed in a radially inner surface of the ring 36, and a first inner intermediate portion 32E located between the first inner edge 32C and the second inner edge 32D. The first inner intermediate portion 32E and the second inner edge 32D are equal in maximum diameter. More specifically, in an example, the first inner intermediate portion 32E is located between the first inner edge 32C and the second inner edge 32D in the longitudinal direction of the first inner recess 32.

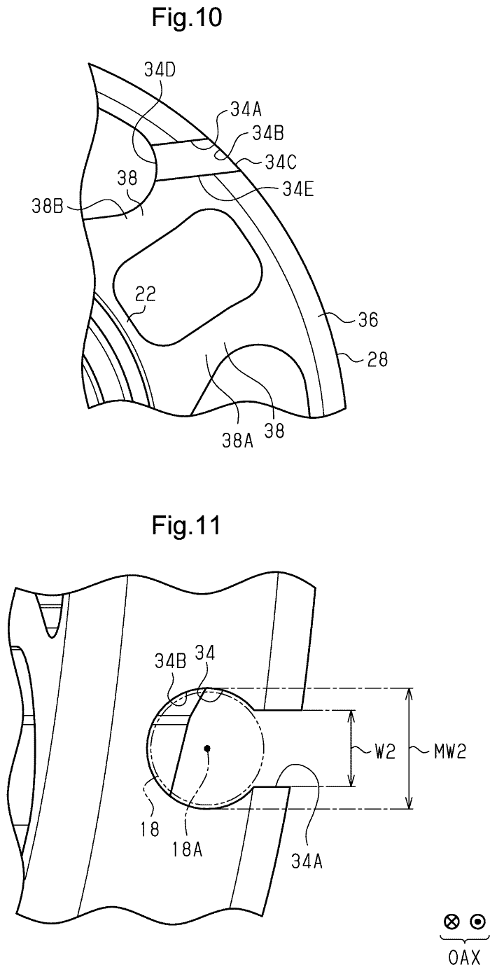

As shown in FIG. 10, with reference to FIG. 5, the first outer recess 34 has a first axial outer opening 34A facing away from the plane P1. The first outer recess 34 has a first outer additional opening 34B which opens in the first outer surface 28. The first outer spoke 18 extends through the first outer additional opening 34B.

As shown in FIG. 7, the first outer recess 34 is located a second distance D2 away from the hub body 22 in a first outer spoke axial direction OAX in which the first outer spoke 18 received in the first outer recess 34 extends. The second distance D2 is greater than a second length L2 of the first outer recess 34 in the first outer spoke axial direction OAX.

In an example, the first outer recess 34 extends straight and has a second length L2. As shown in FIG. 11, the first axial outer opening 34A of the first outer recess 34 has a second width W2 in a second direction orthogonal to a longitudinal direction of the first outer recess 34. The second width W2 is less than a maximum width MW2 of the first outer recess 34 in the second direction. In an example, the second width W2 of the first axial outer opening 34A of the first outer recess 34 is greater than or equal to one-half of the maximum width MW2 of the first outer recess 34 in the second direction.

As shown in FIG. 10, the first outer recess 34 includes a first outer edge 34C that opens in the first outer surface 28, a second outer edge 34D disposed in a radially inner surface of the ring 36, and a first outer intermediate portion 34E located between the first outer edge 34C and the second outer edge 34D. The first outer intermediate portion 34E and the second outer edge 34D are equal in maximum diameter. More specifically, in an example, the first outer intermediate portion 34E is located between the first outer edge 34C and the second outer edge 34D in the longitudinal direction of the first outer recess 34.

As shown in FIG. 5, the first outer edge 34C of the first outer recess 34 and the first inner edge 32C of the first inner recess 32 are located at positions separated by the same distance from the central axis C1 in the radial direction.

As shown in FIG. 5, the first inner recess 32 is entirely offset from the first outer recess 34 in the circumferential direction R. In an example, the most recessed point of the first inner additional opening 32B from an axial outer edge of each first inner recess 32 is offset from the most recessed point of the first outer additional opening 34B from an axial inner edge of each first outer recess 34 in the axial direction X and the circumferential direction R.

Hence, the first inner additional openings 32B of the first inner recesses 32 and the first outer additional openings 34B of the first outer recesses 34 are alternately arranged in a meandering manner along the outer circumferential surface of the ring 36 as viewed in the radial direction Y.

This can define narrow axial width portions and wide axial width portions, alternately arranged in the first outer surface 28 of the first spoke seats portion 26 as viewed in the radial direction Y, thereby resulting in a meander shaped first outer surface 28 of the first spoke seats portion 26 that continuously extends in the circumferential direction R.

As shown in FIGS. 6 and 7, as viewed in the axial direction X, in each first spoke seats section 30, the first inner recess 32 does not overlap with the first outer recess 34. As shown in FIG. 6, as viewed in the axial direction X, a distance R1, in the circumferential direction of the ring 36, from the first inner recess 32 in one first spoke seats section 30 to the first outer recess 34 of the same first spoke seats section 30 differs from a distance R2, in the circumferential direction of the ring 36, from the first inner recess 32 to the first outer recess 34 of an adjacent first spoke seats section 30. In an example, the distance R1 is shorter than the distance R2.

As shown in FIG. 7, as viewed in the axial direction X, the distance R1, which is from the first outer recess 34 in one first spoke seats section 30 to the first inner recess 32 in the same first spoke seats section 30, differs from a distance R3, in the circumferential direction of the ring 36, from the first outer recess 34 to the first inner recess 32 in an adjacent first spoke seats section 30. In an example, the distance R1 is shorter than the distance R3.

The first inner spoke 16 includes, for example, carbon fiber reinforced plastics (CFRP). The first inner spoke 16 can include a metal material.

With reference to FIGS. 2 and 12 to 17, the first spokes 14A, namely, the first inner spoke 16 and the first outer spoke 18, will be described. In the present embodiment, the first inner spoke 16 and the first outer spoke 18 have the same structure. The first inner spoke 16 refers to a first spoke 14A that is coupled to the first inner recess 32. The first outer spoke 18 refers to a first spoke 14A that is coupled to the first outer spoke 18.

As shown in FIG. 2, in each first spoke seats sections 30, the first inner spoke 16 intersects with the first outer spoke 18 at an intersecting position IP as viewed from the axial direction X. The first outer spoke 18 is located farther from the axial center position ACP1 than the first inner spoke 16 at the intersecting position IP.

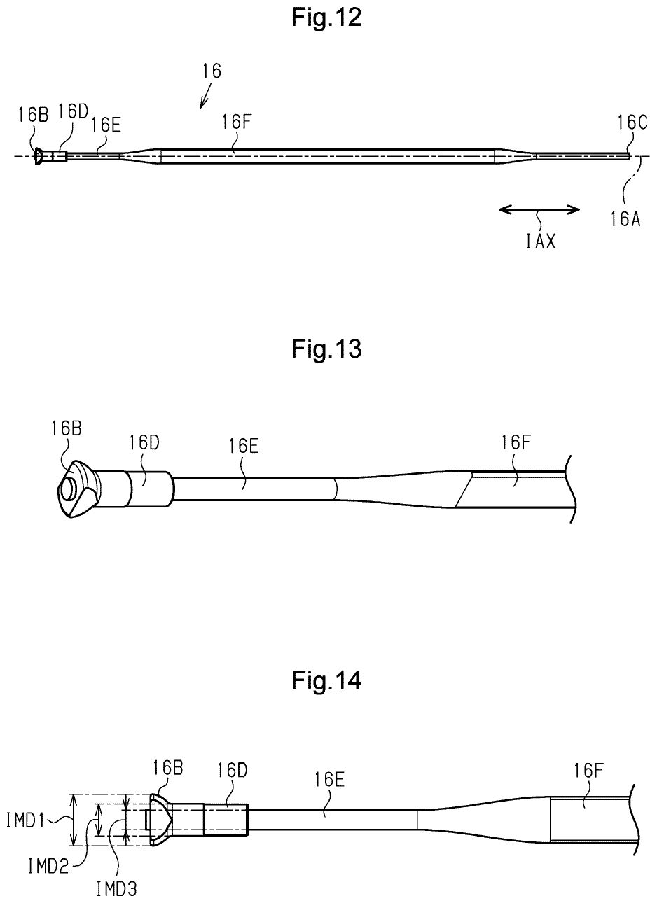

The first inner spoke 16 will now be described further in detail with reference to FIGS. 12 to 14. The first inner spoke 16 includes an inner spoke axis 16A, a first inner spoke end 16B, a second inner spoke end 16C, a first inner spoke portion 16D, and a second inner spoke portion 16E. The inner spoke axis 16A defines a first inner spoke axial direction IAX. The first inner spoke end 16B is attached to the hub 20 in the first inner spoke axial direction IAX. The second inner spoke end 16C is attached to the rim 12 in the first inner spoke axial direction IAX. The first inner spoke portion 16D extends continuously from the first inner spoke end 16B and is located closer to the second inner spoke end 16C than the first inner spoke end 16B. The second inner spoke portion 16E extends continuously from the first inner spoke portion 16D and is located closer to the second inner spoke end 16C than the first inner spoke portion 16D.

In an example, the first inner spoke 16 can further include a third inner spoke portion 16F extending continuously from the second inner spoke portion 16E. The first inner spoke axial direction IAX also refers to the direction in which the first inner spoke 16 received in the first inner recess 32 extends.

In an example, the wheel 10 includes the hub 20, the first inner spoke 16, and the rim 12.

As shown in FIG. 14, a maximum diameter IMD1 of the first inner spoke end 16B is greater than a maximum diameter IMD2 of the first inner spoke portion 16D. The maximum diameter IMD2 of the first inner spoke portion 16D is greater than a maximum diameter IMD3 of the second inner spoke portion 16E. As shown in FIG. 6, in an example, the first distance D1 is greater than a sum of a length of the first inner spoke end 16B and a length of the first inner spoke portion 16D.

Referring to FIGS. 9 and 14, in an example, the first width W1 is less than the maximum diameter IMD2 of the first inner spoke portion 16D and greater than the maximum diameter IMD3 of the second inner spoke portion 16E. The first width W1 is also less than the maximum diameter IMD1 of the first inner spoke end 16B.

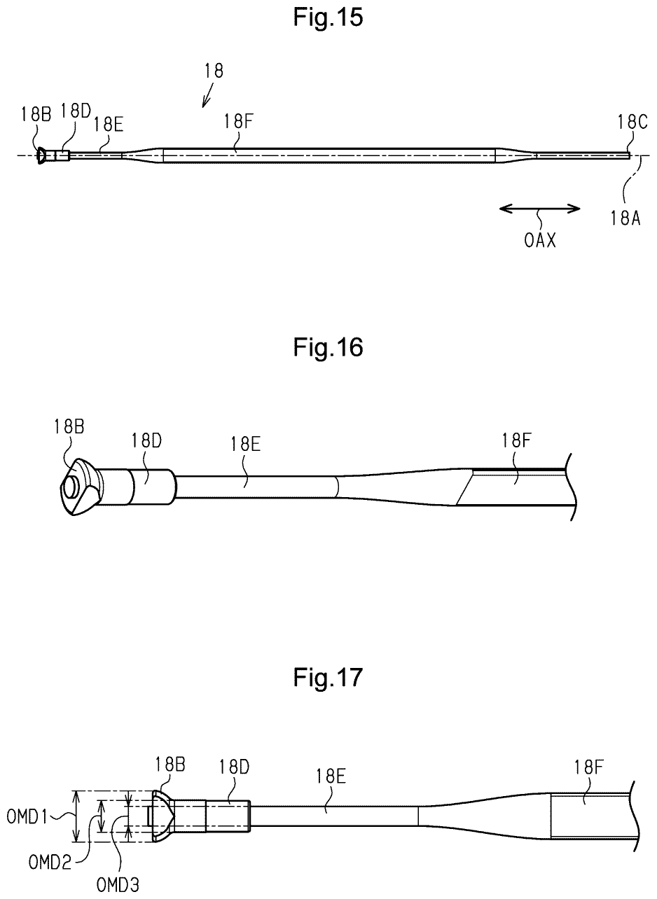

The first outer spoke 18 will now be described further in detail with reference to FIGS. 15 to 17. The first outer spoke 18 includes, for example, carbon fiber reinforced plastics (CFRP). The first outer spoke 18 can include a metal material.

The first outer spoke 18 includes an outer spoke axis 18A, a first outer spoke end 18B, a second outer spoke end 18C, a first outer spoke portion 18D, and a second outer spoke portion 18E. The outer spoke axis 18A defines a first outer spoke axial direction OAX. The first outer spoke end 18B is attached to the hub 20 in the first outer spoke axial direction OAX. The second outer spoke end 18C is attached to the rim 12 in the first outer spoke axial direction OAX. The first outer spoke portion 18D extends continuously from the first outer spoke end 18B and is located closer to the second outer spoke end 18C than the first outer spoke end 18B. The second outer spoke portion 18E extends continuously from the first outer spoke portion 18D and is located closer to the second outer spoke end 18C than the first outer spoke portion 18D.

In an example, the first outer spoke 18 can further include a third outer spoke portion 18F extending continuously from the second outer spoke portion 18E. The first outer spoke axial direction OAX also refers to the direction in which the first outer spoke 18 received in the first outer recess 34 extends. In an example, the wheel 10 includes the hub 20, the first outer spoke 18, and the rim 12.

As shown in FIG. 17, a maximum diameter OMD1 of the first outer spoke end 18B is greater than a maximum diameter OMD2 of the first outer spoke portion 18D. The maximum diameter OMD2 of the first outer spoke portion 18D is greater than a maximum diameter OMD3 of the second outer spoke portion 18E. As shown in FIG. 7, in an example, the second distance D2 is greater than a sum of a length of the first outer spoke end 18B and a length of the first outer spoke portion 18D.

Referring to FIGS. 11 and 17, in an example, the second width W2 is less than the maximum diameter OMD2 of the first outer spoke portion 18D and greater than the maximum diameter OMD3 of the second outer spoke portion 18E. The second width W2 is also less than the maximum diameter OMD1 of the first outer spoke end 18B.

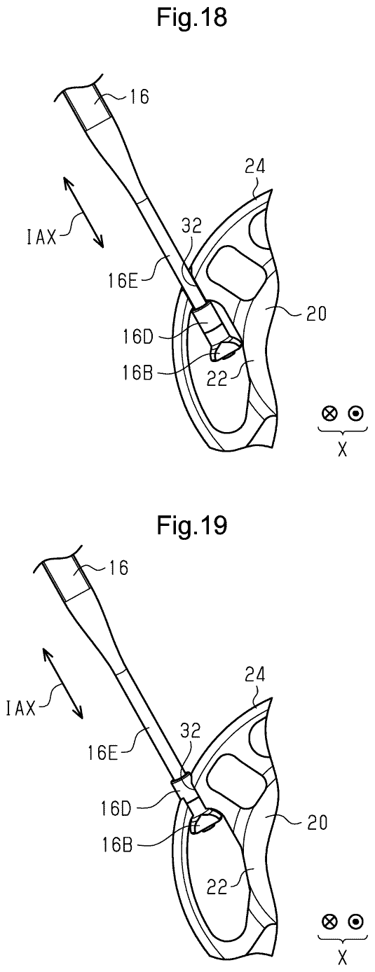

A procedure for coupling the first inner spoke 16 to the wheel 10, more specifically, to the hub 20 and the rim 12, will now be described with reference to FIGS. 18 and 19. As shown in FIG. 18, the second inner spoke portion 16E, the maximum diameter IMD3 of which is less than the first width W1 of the first axial inner opening 32A, is received in the first inner recess 32 from an axially inner side of the hub 20.

In this state, the first inner spoke end 16B and the first inner spoke portion 16D are accommodated in an open area surrounded by the ring 36, the hub body 22, and the bridges 38 of two adjacent ones of the first spoke seats sections 30. The open area is sized so that the first inner spoke 16 does not interfere with the hub 20 during the coupling procedure.

The first inner spoke 16 is moved in the first inner spoke axial direction IAX so that the first inner spoke portion 16D is drawn into the first inner recess 32 and the first inner spoke end 16B comes into contact with the radial inner opening of the first inner recess 32. Since the maximum diameter IMD1 of the first inner spoke end 16B is greater than the maximum width MW1 of the first inner recess 32, the first inner spoke end 16B is used as a stopper that hinders further movement of the first inner spoke 16 through the first inner recess 32 in the first inner spoke axial direction IAX.

In a state in which the first inner spoke portion 16D is received in the first inner recess 32 and the first inner spoke end 16B is in contact with the radial inner opening of the first inner recess 32, the first inner spoke 16 is coupled to the rim 12. The first inner spoke 16 can be coupled to the rim 12 through a known process. In an example, the second inner spoke end 16C is fastened to the rim 12. As a result, the first inner spoke 16 is coupled to the wheel 10.

In this case, the first inner spoke 16 is coupled to the hub 20 and the rim 12 by simply arranging the first inner spoke end 16B and the first inner spoke portion 16D in the vicinity of the hub 20. The second inner spoke end 16C, which is opposite the first inner spoke end 16B, does not have to be arranged in the vicinity of the hub 20 during the coupling procedure.

To remove the first inner spoke 16 from the hub 20, the first inner spoke 16 is uncoupled from the rim 12 and then moved in the first inner spoke axial direction IAX until the second inner spoke portion 16E is located in the first inner recess 32. From this position, the first inner spoke 16 is moved inward in the axial direction X. As a result, the first inner spoke 16 is removed from the hub 20.

With this structure, the first inner spoke 16 can be removed from the hub 20 without removing the first outer spoke 18 from the hub 20. In other words, the first inner spoke 16 can be individually removed from the hub 20 while the other spokes remain on the hub 20.

In the same manner as the first inner spoke 16, the first outer spoke 18 can be coupled to the wheel 10. The second outer spoke portion 18E, the maximum diameter OMD3 of which is less than the second width W2 of the first axial outer opening 34A, is received in the first outer recess 34 in the axial direction X.

In this state, the first outer spoke end 18B and the first outer spoke portion 18D are accommodated in an open area surrounded by the ring 36, the hub body 22, and the bridges 38 in two adjacent ones of the first spoke seats sections 30. The space is sized so that the first outer spoke 18 does not interfere with the hub 20 during the coupling procedure.

The first outer spoke 18 is moved in the first outer spoke axial direction OAX so that the first outer spoke portion 18D is drawn into the first outer recess 34 and the first outer spoke end 18B comes into contact with the radial inner opening of the first outer recess 34. Since the maximum diameter OMD1 of the first outer spoke end 18B is greater than the maximum width MW2 of the first outer recess 34, the first outer spoke end 18B is used as a stopper that hinders further movement of the first outer spoke 18 through the first outer recess 34 in the first outer spoke axial direction OAX.

In a state in which the first outer spoke portion 18D is received in the first outer recess 34 and the first outer spoke end 18B is in contact with the radial inner opening of the first outer recess 34, the first outer spoke 18 is coupled to the rim 12. The first outer spoke 18 can be coupled to the rim 12 through a known process. In an example, the second outer spoke end 18C is fastened to the rim 12. As a result, the first outer spoke 18 is coupled to the wheel 10.

In this case, the first outer spoke 18 is coupled to the hub 20 and the rim 12 by simply arranging the first outer spoke end 18B and the first outer spoke portion 18D in the vicinity of the hub 20. The second outer spoke end 18C, which is opposite the first outer spoke end 18B, does not have to be arranged in the vicinity of the hub 20 during the coupling procedure.

To remove the first outer spoke 18 from the hub 20, the first outer spoke 18 is uncoupled from the rim 12 and then moved in the first outer spoke axial direction OAX until the second outer spoke portion 18E becomes located in the first outer recess 34. From this position, the first outer spoke 18 is moved outward in the axial direction X. As a result, the first outer spoke 18 is removed from the hub 20.

With this structure, the first outer spoke 18 can be removed from the hub 20 without removing the first inner spoke 16 from the hub 20. In other words, the first outer spoke 18 can be individually removed from the hub 20 while the other spokes remain on the hub 20.

### Second Embodiment

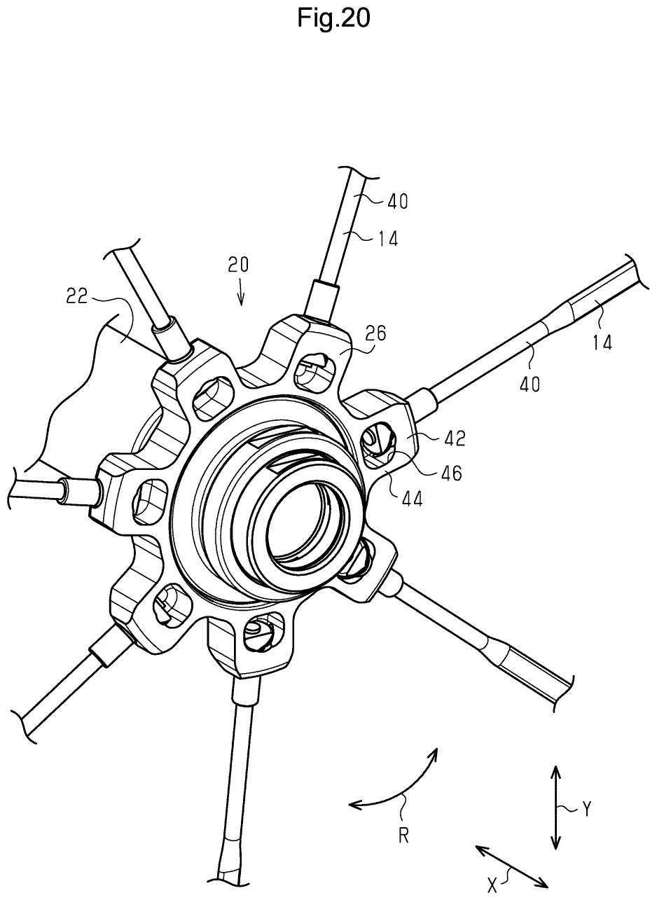

FIG. 20 shows a second embodiment of a wheel 10, which is, for example, a front wheel. The wheel 10 includes a plurality of spokes 14. The plurality of spokes 14 include first spokes 14A and second spokes 40. The first spokes 14A include, for example, the first inner spoke 16 and the first outer spoke 18. The second spoke 40 has the same structure as the first inner spoke 16 and the first outer spoke 18.

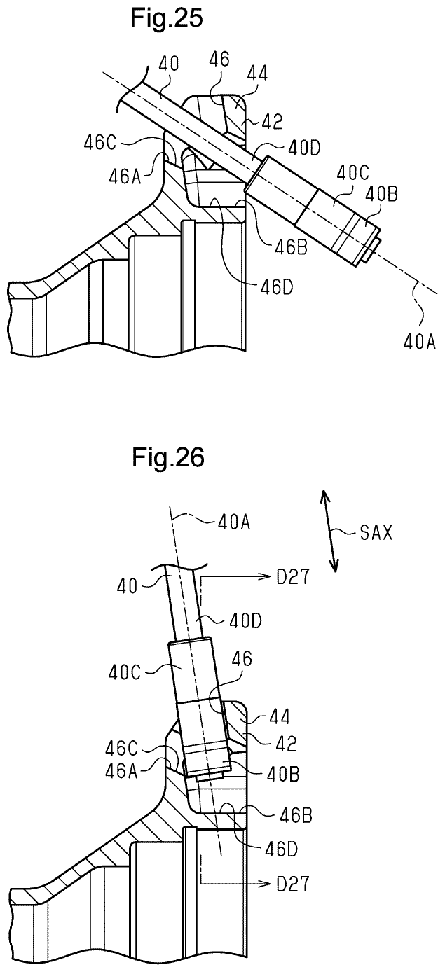

As shown in FIG. 25, the second spoke 40 includes a second spoke axis 40A, a second spoke end 40B, a first part 40C, and a second part 40D. The second spoke axis 40A corresponds to the inner spoke axis 16A. The second spoke end 40B corresponds to the first inner spoke end 16B. The first part 40C corresponds to the first inner spoke portion 16D. The second part 40D corresponds to the second inner spoke portion 16E.

In the present embodiment of the hub 20, the second spoke seats portion 26 and the first spoke seats portion 24 have different structures. The first spoke seats portion 24 and the second spoke seats portion 26 are each defined, for example, in a flange extending radially outward from the hub body 22.

In the description hereafter, the second spoke seats portion 26 refers to the spoke seats portion located at a side corresponding to the right side of a rider facing in a traveling direction of the human-powered vehicle. In the present embodiment, the second spokes 40 are coupled to the second spoke seats portion 26 so that the second spokes 40 extend in the radial direction Y.

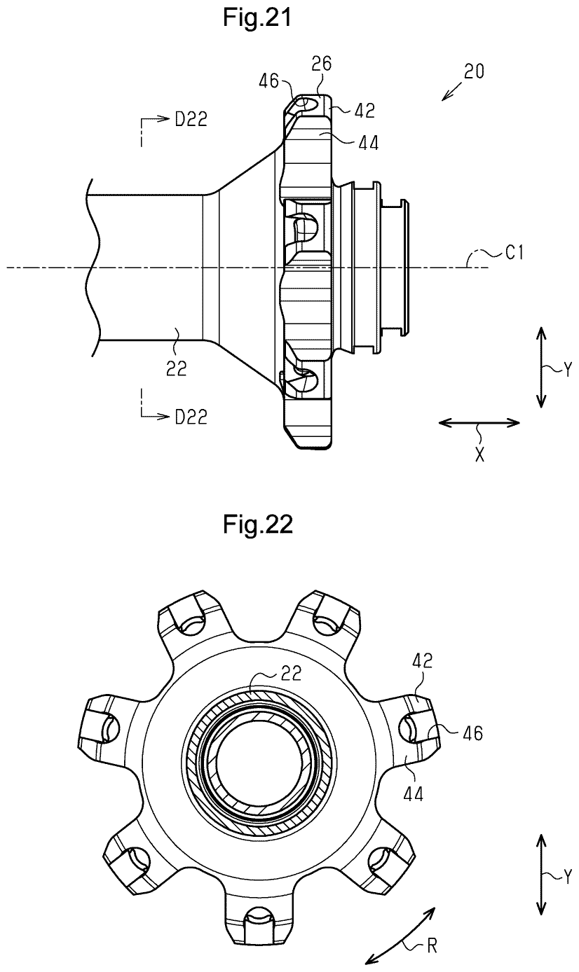

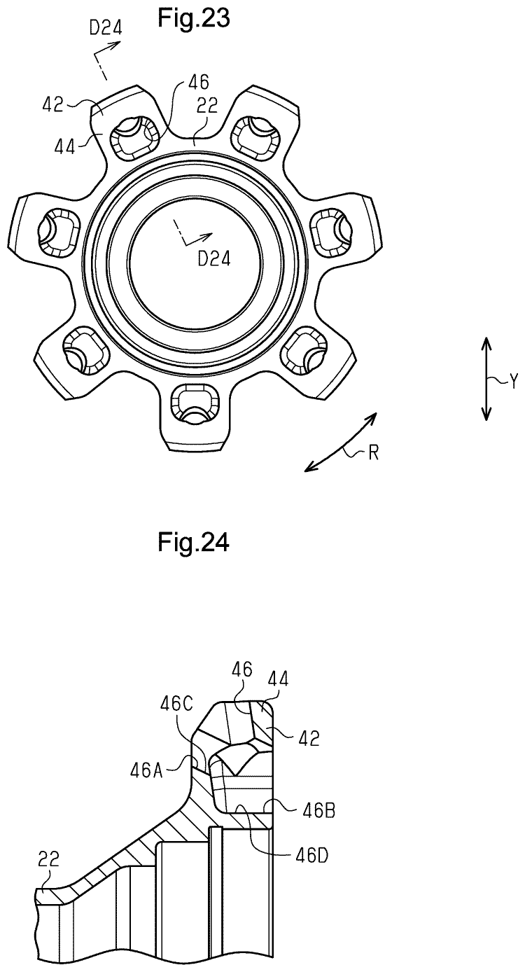

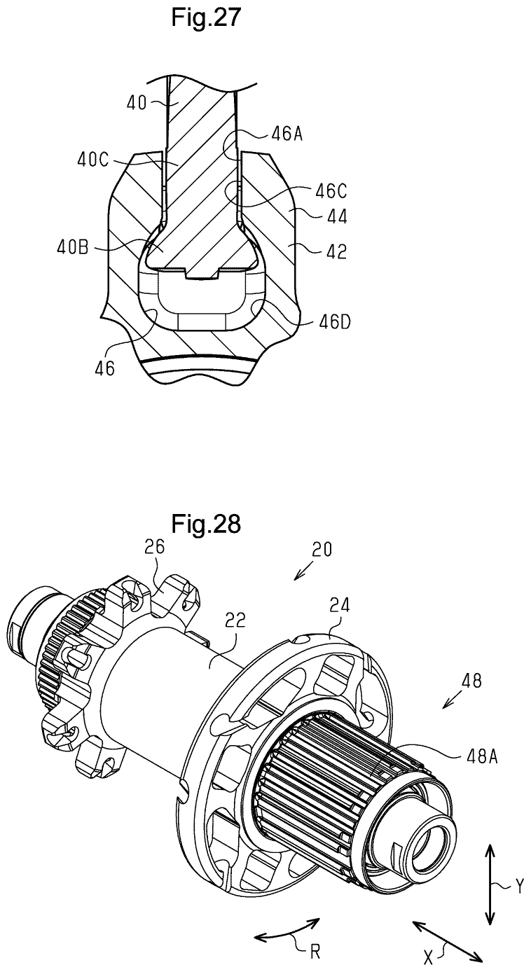

The first spoke seats portion 24 of the present embodiment has the same structure as the first spoke seats portion 24 and the second spoke seats portion 26 of the first embodiment. The second spoke seats portion 26 of the present embodiment will now be described further in detail with reference to FIGS. 20 to 27.

As shown in FIG. 20, the second spoke seats portion 26 of the present embodiment includes a plurality of second spoke seats sections 42. The second spoke 40 is attached to each of the second spoke seats sections 42. The second spoke seats sections 42 are, for example, disposed at equal intervals in the circumferential direction R.

As shown in FIG. 24, each second spoke seats section 42 includes, for example, a protrusion 44 projecting from the hub body 22. The second spoke seats section 42 includes, for example, a spoke socket 46 configured to receive the second spoke 40. The spoke socket 46 extends through the second spoke seats portion 26 from the axially inner side to the axially outer side.

The spoke socket 46 has an axial inner opening 46A and an axial outer opening 46B with respect to the second spoke seats portion 26. The axial inner opening 46A of the spoke socket 46 is located radially outward from the axial outer opening 46B of the spoke socket 46.

The spoke socket 46 includes an axial inner part 46C and an axial outer part 46D. As the axial inner part 46C extends from the axially inner side toward the axially outer side, the axial inner part 46C is inclined from a radially outer side toward a radially inner side. The axial outer part 46D extends in the axial direction X.

The maximum inner diameter of the axial outer part 46D is greater than the maximum inner diameter of the axial inner part 46C. The maximum inner diameter of the axial outer part 46D is greater than the maximum diameter of the second spoke end 40B. The maximum inner diameter of the axial inner part 46C is smaller than the maximum diameter of the second spoke end 40B.

A procedure for coupling the second spoke 40 to the hub 20 will now be described with reference to FIGS. 25 to 27. As shown in FIG. 25, the second spoke 40 is inserted into the spoke socket 46 from the axial outer opening 46B. The second spoke 40 is further moved in a second spoke axial direction SAX, in which the second spoke 40 received in the spoke socket 46 extends, until the first part 40C becomes located in the axial inner part 46C of the spoke socket 46. The movement of the second spoke 40 in the second spoke axial direction SAX is stopped as the second spoke end 40B comes into contact with the edge of the axial inner part 46C since the maximum diameter of the second spoke end 40B is larger than the maximum inner diameter of the axial inner part and smaller than the maximum inner diameter of the axial outer part.

In the state shown in FIG. 26 in which the first part 40C is located in the axial inner part, the second spoke 40 is coupled to the rim 12. The second spoke 40 can be coupled to the rim 12 through a known process. As a result, the second spoke 40 is coupled to the wheel 10.

### Modified Examples

The description related to the embodiments exemplifies, without any intention to limit, applicable forms of a hub for a human-powered vehicle and a wheel for a human-powered vehicle according to the present disclosure. The hub and the wheel according to the present disclosure can be applied to, for example, modified examples of the embodiments that are described below and combinations of at least two of the modified examples that do not contradict each other.

In the embodiments, the wheel 10 is a front wheel. Alternatively, the wheel 10 can be a rear wheel. FIG. 28 shows an example of a rear wheel. The rear wheel includes a sprocket mount portion 48 to which a plurality of sprockets is mounted. The sprocket mount portion 48 has a spline 48A engaging with another spline formed at the plurality of sprockets. The spline 48A extends in the axial direction X. The number of sprockets is currently a maximum of 12, but it is possible to mount 13 sprockets by extending the spline length in the axial direction by about 2.5 mm. In FIG. 28, the first spoke seats portion 24 refers to the spoke seats portion located at a side corresponding to the right side of a rider facing a traveling direction of the human-powered vehicle. The second spoke seats portion 26 refers to the spoke seats portion located at a side corresponding to the left side of the rider. In this modified example, the second spoke seats portion 26 has the same structure as the second spoke seats portion 26 of the second embodiment.

In a modified example, the first inner spoke 16 is not limited to those shown in FIGS. 12 to 14 and can be changed in any manner.

In a modified example, the first outer spoke 18 is not limited to those shown in FIGS. 15 to 17 and can be changed in any manner.

In the first embodiment, the first inner recess 32 is entirely offset from the first outer recess 34 in the circumferential direction R. Alternatively, the first inner recess 32 and the first outer recess 34 can at least partially overlap each other in the circumferential direction R.

In the first embodiment, the number of the bridges 38 is equal to the sum of the first inner recesses 32 and the first outer recesses 34. Alternatively, the number of the bridges 38 can differ from the sum of the first inner recesses 32 and the first outer recesses 34. In an example, the number of the bridges 38 can be greater than the sum of the first inner recesses 32 and the first outer recesses 34.

In the first embodiment, the first width W1 of the first axial inner opening 32A of the first inner recess 32 is greater than or equal to one-half of the maximum width MW1 of the first inner recess 32 in the first direction. Alternatively, the first width W1 of the first axial inner opening 32A of the first inner recess 32 can be less than one-half of the maximum width MW1 of the first inner recess 32 in the first direction.

In the first embodiment, the first inner intermediate portion 32E and the second inner edge 32D are equal in maximum diameter. Alternatively, the first inner intermediate portion 32E and the second inner edge 32D can have different maximum diameters.

In the first embodiment, the second width W2 of the first axial outer opening 34A of the first outer recess 34 is greater than or equal to one-half of the maximum width MW2 of the first outer recess 34 in the second direction. Alternatively, the second width W2 of the first axial outer opening 34A of the first outer recess 34 can be less than one-half of the maximum width MW2 of the first outer recess 34 in the second direction.

In the first embodiment, the first outer intermediate portion 34E and the second outer edge 34D are equal in maximum diameter. Alternatively, the first outer intermediate portion 34E and the second outer edge 34D can have different maximum diameters.

The phrase “at least one of” as used in this disclosure means “one or more” of a desired choice. For one example, the phrase “at least one of” as used in this disclosure means “only one single choice” or “both of two choices” if the number of its choices is two. For another example, the phrase “at least one of” as used in this disclosure means “only one single choice” or “any combination of equal to or more than two choices” if the number of its choices is equal to or more than three. Also, the term “and/or” as used in this disclosure means “either one or both of”. For instance, the phrase “at least one of A and B” encompasses (1) A alone, (2), B alone, and (3) both A and B. The phrase “at least one of A, B, and C” encompasses (1) A alone, (2), B alone, (3) C alone, (4) both A and B, (5) both B and C, (6) both A and C, and (7) all A, B, and C. In other words, the phrase “at least one of A and B” does not mean “at least one of A and at least one of B” in this disclosure.

1. A hub for a wheel of a human-powered vehicle, the hub comprising:
a hub body including a central axis defining an axial direction, a radial direction, and a circumferential direction, the hub body defining a plane which is perpendicular to the axial direction and which contains an axial center position of the hub body;
a first spoke seats portion configured to support spokes, the first spoke seats portion including
a first outer surface at least partially extending in the circumferential direction, and
a plurality of first spoke seats sections disposed in the circumferential direction, each of the plurality of first spoke seats sections including a first inner recess and a first outer recess, the first outer recess being located farther from the axial center position than the first inner recess in the axial direction,
the first inner recess receiving a first inner spoke, the first outer recess receiving a first outer spoke, the first inner spoke intersecting with the first outer spoke at an intersecting position as viewed from the axial direction, the first outer spoke being located farther from the axial center position than the first inner spoke at the intersecting position,
the first inner recess having a first axial inner opening facing toward the plane, the first inner recess having a first inner additional opening which opens in the first outer surface, the first inner spoke extending through the first inner additional opening, and
the first outer recess having a first axial outer opening facing away from the plane, the first outer recess having a first outer additional opening which opens in the first outer surface, the first outer spoke extending through the first outer additional opening; and
a second spoke seats portion configured to support spokes, the second spoke seats portion and the first spoke seats portion being arranged at opposite sides of the axial center position in the axial direction.

2. The hub according to claim 1, wherein the first inner recess is entirely offset from the first outer recess in the circumferential direction.

3. The hub according to claim 1, wherein the first spoke seats portion includes
a ring arranged outward from the hub body in the radial direction and extending continuously around the hub body in the circumferential direction, and
bridges extending in the radial direction and connecting the hub body and the ring,
wherein the first inner recess and the first outer recess are provided in the ring.

4. The hub according to claim 3, wherein the first inner recess is located a first distance away from the hub body in a first inner spoke axial direction in which the first inner spoke received in the first inner recess extends, the first distance being greater than a first length of the first inner recess in the first inner spoke axial direction.

5. The hub according to claim 3, wherein the first outer recess is located a second distance away from the hub body in a first outer spoke axial direction in which the first outer spoke received in the first outer recess extends, the second distance being greater than a second length of the first outer recess in the first outer spoke axial direction.

6. The hub according to claim 3, wherein a number of the bridges is equal to a sum of the first inner recesses and the first outer recesses.

7. The hub according to claim 1, wherein
the first inner recess extends straight and has a first length,
the first axial inner opening of the first inner recess has a first width in a first direction orthogonal to a longitudinal direction of the first inner recess, and
the first width is less than a maximum width of the first inner recess in the first direction.

8. The hub according to claim 7, wherein the first width of the first axial inner opening of the first inner recess is greater than or equal to one-half of the maximum width of the first inner recess in the first direction.

9. The hub according to claim 3, wherein
the first inner recess includes a first inner edge that opens in the first outer surface, a second inner edge disposed in a radially inner surface of the ring, and a first inner intermediate portion located between the first inner edge and the second inner edge, and
the first inner intermediate portion and the second inner edge being equal in maximum diameter.

10. The hub according to claim 1, wherein
the first outer recess extends straight and has a second length,
the first axial outer opening of the first outer recess has a second width in a second direction orthogonal to a longitudinal direction of the first outer recess, and
the second width is less than a maximum width of the first outer recess in the second direction.

11. The hub according to claim 10, wherein the second width of the first axial outer opening of the first outer recess is greater than or equal to one-half of the maximum width of the first outer recess in the second direction.

12. The hub according to claim 1, wherein
the first outer recess includes a first outer edge that opens in the first outer surface, a second outer edge disposed in a radially inner surface of the ring, and a first outer intermediate portion located between the first outer edge and the second outer edge, and
the first outer intermediate portion and the second outer edge being equal in maximum diameter.

13. A wheel for a human-powered vehicle, the wheel comprising:
the hub according to claim 1;
the first inner spoke;
the first outer spoke; and
a rim.

14. The wheel according to claim 13, wherein
the first inner spoke includes
an inner spoke axis defining a first inner spoke axial direction,
a first inner spoke end attached to the hub in the first inner spoke axial direction,
a second inner spoke end attached to the rim in the first inner spoke axial direction,
a first inner spoke portion extending continuously from the first inner spoke end and located closer to the second inner spoke end than the first inner spoke end, and
a second inner spoke portion extending continuously from the first inner spoke portion and located closer to the second inner spoke end than the first inner spoke portion,
a maximum diameter of the first inner spoke end is greater than a maximum diameter of the first inner spoke portion,
the maximum diameter of the first inner spoke portion is greater than a maximum diameter of the second inner spoke portion,
the first outer spoke includes
an outer spoke axis defining a first outer spoke axial direction,
a first outer spoke end attached to the hub in the first outer spoke axial direction,
a second outer spoke end attached to the rim in the first outer spoke axial direction,
a first outer spoke portion extending continuously from the first outer spoke end and located closer to the second outer spoke end than the first outer spoke end, and
a second outer spoke portion extending continuously from the first outer spoke portion and located closer to the second outer spoke end than the first outer spoke portion,
a maximum diameter of the first outer spoke end is greater than a maximum diameter of the first outer spoke portion, and
the maximum diameter of the first outer spoke portion is greater than a maximum diameter of the second outer spoke portion.

15. A wheel for a human-powered vehicle, the wheel comprising:
the hub according to claim 4;
the first inner spoke; and
a rim, wherein
the first inner spoke includes
an inner spoke axis defining a first inner spoke axial direction,
a first inner spoke end attached to the hub in the first inner spoke axial direction,
a second inner spoke end attached to the rim in the first inner spoke axial direction,
a first inner spoke portion extending continuously from the first inner spoke end and located closer to the second inner spoke end than the first inner spoke end, and
a second inner spoke portion extending continuously from the first inner spoke portion and located closer to the second inner spoke end than the first inner spoke portion,
a maximum diameter of the first inner spoke end is greater than a maximum diameter of the first inner spoke portion,
the maximum diameter of the first inner spoke portion is greater than a maximum diameter of the second inner spoke portion, and
the first distance is greater than a sum of a length of the first inner spoke end and a length of the first inner spoke portion.

16. A wheel for a human-powered vehicle, the wheel comprising:
the hub according to claim 5;
the first outer spoke; and
a rim, wherein
the first outer spoke includes
an outer spoke axis defining a first outer spoke axial direction,
a first outer spoke end attached to the hub in the first outer spoke axial direction,
a second outer spoke end attached to the rim in the first outer spoke axial direction,
a first outer spoke portion extending continuously from the first outer spoke end and located closer to the second outer spoke end than the first outer spoke end, and
a second outer spoke portion extending continuously from the first outer spoke portion and located closer to the second outer spoke end than the first outer spoke portion,
a maximum diameter of the first outer spoke end is greater than a maximum diameter of the first outer spoke portion,
the maximum diameter of the first outer spoke portion is greater than a maximum diameter of the second outer spoke portion, and
the second distance is greater than a sum of a length of the first outer spoke end and a length of the first outer spoke portion.

17. A wheel for a human-powered vehicle, the wheel comprising:
the hub according to claim 7;
the first inner spoke; and
a rim, wherein
the first inner spoke includes
an inner spoke axis defining a first inner spoke axial direction,
a first inner spoke end attached to the hub in the first inner spoke axial direction,
a second inner spoke end attached to the rim in the first inner spoke axial direction,
a first inner spoke portion extending continuously from the first inner spoke end and located closer to the second inner spoke end than the first inner spoke end, and
a second inner spoke portion extending continuously from the first inner spoke portion and located closer to the second inner spoke end than the first inner spoke portion,
a maximum diameter of the first inner spoke end is greater than a maximum diameter of the first inner spoke portion,
the maximum diameter of the first inner spoke portion is greater than a maximum diameter of the second inner spoke portion, and
the first width is less than the maximum diameter of the first inner spoke portion and greater than the maximum diameter of the second inner spoke portion.

18. A wheel for a human-powered vehicle, the wheel comprising:
the hub according to claim 10;
the first outer spoke; and
a rim, wherein
the first outer spoke includes
an outer spoke axis defining a first outer spoke axial direction,
a first outer spoke end attached to the hub in the first outer spoke axial direction,
a second outer spoke end attached to the rim in the first outer spoke axial direction,
a first outer spoke portion extending continuously from the first outer spoke end and located closer to the second outer spoke end than the first outer spoke end, and
a second outer spoke portion extending continuously from the first outer spoke portion and located closer to the second outer spoke end than the first outer spoke portion,
a maximum diameter of the first outer spoke end is greater than a maximum diameter of the first outer spoke portion,
the maximum diameter of the first outer spoke portion is greater than a maximum diameter of the second outer spoke portion, and
the second width is less than the maximum diameter of the first outer spoke portion and greater than the maximum diameter of the second outer spoke portion.
